(19) United States
(12) Patent Application Publication
(10) Pub. No.: US 2025/0380339 A1
(43) Pub. Date: Dec. 11, 2025

(54) BAFFLE ARRANGEMENT FOR LAMP COOLING

(71) Applicant: Applied Materials, Inc., Santa Clara, CA (US)

(72) Inventors: Vishwas Kumar PANDEY, Madhya Pradesh (IN); Ala MORADIAN, Sunnyvale, CA (US); Anil Kumar BODEPUDI, Bangalore (IN)

(21) Appl. No.: 18/736,808

(22) Filed: Jun. 7, 2024

(51) Int. Cl. H05B 3/00; H05B 1/02; H05B 3/06

(52) U.S. Cl. CPC H05B 3/0047; H05B 1/0233; H05B 3/06

(57) ABSTRACT

A process chamber equipped with a baffle arranged to enhance cooling of lamps of the process chamber is provided. In one aspect, a process chamber includes an upper housing defining an upper chamber. The process chamber also has a shroud and an upper lamp module having a lamp holder arranged to hold a plurality of upper lamps. The shroud is connected to the upper lamp module. The shroud, the upper lamp module, and the upper housing define an outer passage of the upper chamber. The process chamber also includes a baffle separating the outer passage into an upper section and a lower section. The baffle is arranged to facilitate a flow of a cooling fluid flowing through the lower section to the upper lamps to provide cooling thereto. A method of operating a processing system having a process chamber is also provided.

### BACKGROUND

### FIELD

Embodiments of the present disclosure generally relate to a baffle arrangement for cooling lamps for use in process chambers, such as semiconductor process chambers.

### DESCRIPTION OF THE RELATED ART

A process chamber, such as a semiconductor process chamber, can include lamps that provide heat to a substrate during processing. For instance, a process chamber can include an upper lamp module having a plurality of upper lamps. The upper lamps can be cooled by an air flow directed through an upper chamber assembly. With the upper lamps being operated at ever increasing power levels, there is a need for enhanced cooling of the upper lamps.

### SUMMARY

In one embodiment, a process chamber is provided. The process chamber includes an upper housing defining an upper chamber. The process chamber also includes an upper lamp module having a lamp holder arranged to hold a plurality of upper lamps. Further, the process chamber includes a shroud connected to the upper lamp module, wherein the shroud, the upper lamp module, and the upper housing define an outer passage of the upper chamber. In addition, the process chamber includes a baffle separating the outer passage into an upper section and a lower section. The baffle is arranged to facilitate a flow of a cooling fluid flowing through the lower section to the plurality of upper lamps to provide cooling thereto.

In another embodiment, a process chamber is provided. The process chamber includes an upper housing defining an upper chamber and having a base wall, a lid, and a sidewall extending between and connecting the base wall and the lid; an upper lamp module positioned within the upper chamber and having a lamp holder arranged to hold a plurality of upper lamps; a shroud connected to the upper lamp module, wherein the shroud, the upper lamp module, and the upper housing define an outer passage of the upper chamber, a gap being defined between the lid and an upper end of the shroud; a baffle connected to the sidewall and extending toward the shroud to separate the outer passage into an upper section and a lower section, an inner end of the baffle being spaced from the shroud to define a gap; and an inlet duct arranged to deliver a cooling fluid to the lower section. The gap defined between the inner end of the baffle and the shroud allows a portion of the cooling fluid flowing along the lower section to flow from the lower section into the upper section and through the gap defined between the lid and the upper end of the shroud and facilitates a portion of the cooling fluid flowing through the lower section to flow under the shroud and to the upper lamps to provide cooling thereto.

In yet another embodiment, a method is provided. The method includes providing an upper chamber assembly of a process chamber, the upper chamber assembly comprising: an upper housing defining an upper chamber; an upper lamp module having a lamp holder arranged to hold a plurality of upper lamps; a shroud connected to the upper lamp module, wherein the shroud, the upper lamp module, and the upper housing define an outer passage of the upper chamber; and a baffle separating the outer passage into an upper section and a lower section and being spaced from the shroud by a gap; generating heat with the plurality of upper lamps to process a substrate arranged within a process volume of the process chamber; and flowing a cooling fluid through the upper chamber assembly so that a portion of the cooling fluid flowing through the lower section flows into the upper section through the gap and a portion of the cooling fluid flowing through the lower section flows under the shroud and to the plurality of upper lamps to provide cooling thereto.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a schematic cross-sectional view of a processing system according to one embodiment of the present disclosure.

FIG. 2 is a perspective view of an upper chamber assembly of the processing system of FIG. 1.

FIG. 3 is a perspective cross-sectional view of a portion of the upper chamber assembly of FIG. 2.

FIG. 4 is a close-up, cross-sectional view of a portion of the upper chamber assembly of FIG. 2.

FIG. 5 is a close-up, cross-sectional view of a portion of the upper chamber assembly of FIG. 2.

FIG. 6 is a close-up, cross-sectional view of a portion of the upper chamber assembly of FIG. 2, with an adjustable baffle being depicted according to one embodiment of the present disclosure.

FIG. 7 is a cross-sectional view of the upper chamber assembly of FIG. 2 and depicts an example manner in which a cooling fluid can flow through the upper chamber assembly.

FIG. 8 is a flow diagram for a method of operating a processing system.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to process chambers (e.g., semiconductor process chambers) that include a baffle arrangement that can provide enhanced cooling of lamps thereof. In one example aspect, a process chamber can include an upper chamber assembly arranged above a process volume in which a substrate can be processed, e.g., by epitaxial deposition. The process volume can be defined, at least in part, by an upper window such as an upper dome. The upper chamber assembly can include an upper housing defining an upper chamber and a lower housing arranged below the upper housing and defining a lower chamber. The upper chamber assembly can also include an upper lamp module having a lamp holder arranged to hold a plurality of circumferentially-arranged upper lamps. The upper lamps can provide heat to the substrate during processing. The upper chamber assembly can further include a shroud connected to the upper lamp module. The shroud, the upper lamp module, and the upper housing can define an outer passage of the upper chamber. The outer passage is arranged to receive a cooling fluid and can extend circumferentially around the upper lamp module and the shroud. The upper chamber assembly can additionally include a baffle separating the outer passage into an upper section and a lower section. A gap is defined between an inner end of the baffle and the shroud, which allows some cooling fluid to flow into the upper section, over the top of the shroud, and downstream to the lower chamber. Accordingly, the cooling fluid can be focused into the lower section of the outer passage and “choked” at the gap, which enhances the flow of the cooling fluid to the upper lamps. In this regard, the baffle is arranged to facilitate a flow of the cooling fluid flowing through the lower section to cool the upper lamps. Further, in some aspects, not only can the baffle facilitate cooling of the upper lamps, the baffle can enable increased flow uniformity of the cooling fluid over each of the upper lamps and can also provide a more uniform flow of the cooling fluid over the upper dome. Accordingly, the upper chamber assembly can function to provide cooling to components outside of the process volume.

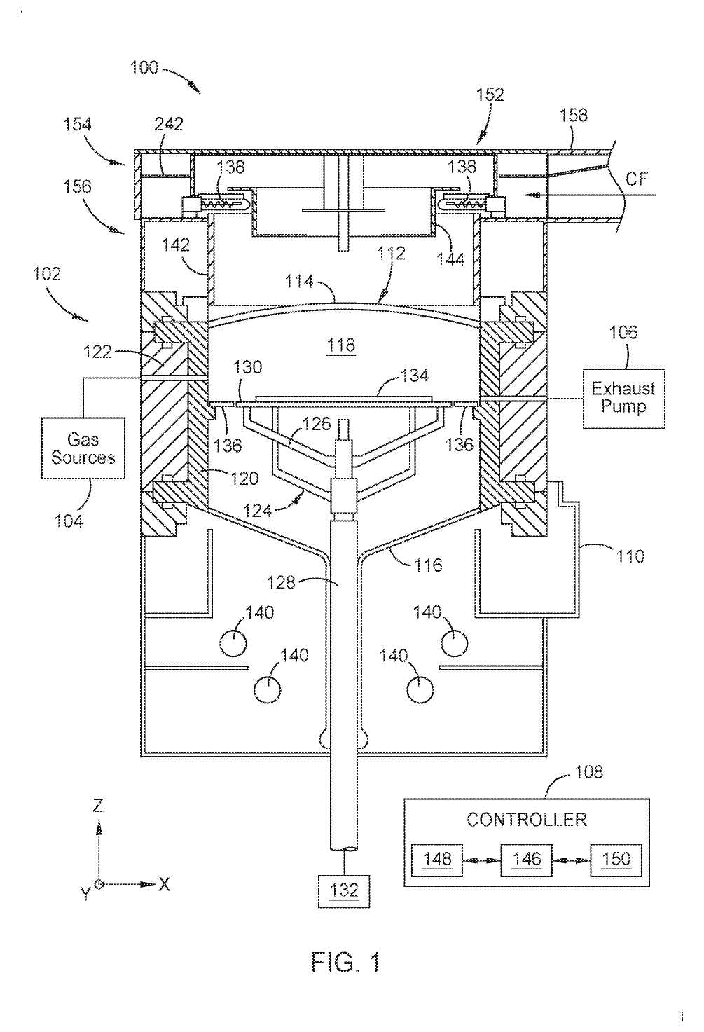

FIG. 1 is a schematic cross-sectional view of a processing system 100 according to one embodiment of the present disclosure. The processing system 100 can be configured to perform epitaxial deposition. While a processing system for performing epitaxial processes is shown and described herein, the inventive aspects of the present disclosure are also applicable to other processing systems capable of providing a controlled thermal cycle that heats a substrate for processes such as, for example, thermal annealing, thermal cleaning, thermal chemical vapor deposition, thermal oxidation, and thermal nitridation.

As shown in FIG. 1, the processing system 100 includes a process chamber 102, one or more gas sources 104, an exhaust pump 106, and a controller 108. For reference, the processing system 100 defines a first direction X, a second direction Y, and a third direction Z, which are mutually perpendicular to one another and form an orthogonal direction system. In at least some embodiments, the first direction X can be a lateral direction, the second direction Y can be a transverse direction, and the third direction Z can be a vertical direction.

The process chamber 102 includes a housing structure 110 made of a process resistant material, such as aluminum or stainless steel, for example 316L stainless steel. The housing structure 110 encloses various functioning elements of the process chamber 102, such as a quartz chamber 112. The quartz chamber 112 includes an upper window 114 such as an upper dome and a lower window 116 such as a lower dome. The quartz chamber 112 encloses a process volume 118. One or more plates 120, 122 can form the sides of the quartz chamber 112.

The process chamber 102 also includes a substrate support assembly 124. The substrate support assembly 124 can include supports 126 and a shaft 128. A susceptor 130 can be positioned on the supports 126. The substrate support assembly 124 can further include an actuator 132 to rotate the shaft 128 and the susceptor 130. A substrate 134 can be positioned on the susceptor 130 during processing, such as during epitaxial deposition.

Gases can be provided to the process volume 118 from the gas sources 104 during deposition and other processes. These gases can be exhausted from the process volume 118 by the exhaust pump 106. The process chamber 102 can further include a preheat ring 136 that can be positioned around the susceptor 130.

The process chamber 102 can also include upper lamps 138 and lower lamps 140 for heating the substrate 134 and/or the process volume 118. In at least some embodiments, the upper lamps 138 and/or the lower lamps 140 can be infrared (IR) or radiant heat lamps, such as tungsten halogen lamps. The upper and lower lamps 138, 140 can provide heat to the substrate though the upper window 114 and the lower window 116, respectively. The upper and lower windows 114, 116 can be transparent, e.g., to IR radiation.

The process chamber 102 further includes an outer reflector 142 and an inner reflector 144. The outer reflector 142 can be positioned around the inner reflector 144. The outer reflector 142 and the inner reflector 144 are positioned outside the upper window 114 and are arranged to reflect IR light radiating from the substrate 134 and the upper window 114 back towards the substrate 134.

The processing system 100 also includes the controller 108 for controlling processes performed by the processing system 100. The controller 108 can be any type of controller used in an industrial setting, such as a programmable logic controller (PLC). The controller 108 includes a processor 146, a memory 148, and input/output (I/O) circuits 150. The controller 108 can further include one or more of the following: power supplies, clocks, communication components (e.g., network interface card), and user interfaces typically found in controllers for semiconductor equipment.

The memory 148 can include non-transitory memory. The non-transitory memory can be used to store one or more programs and settings. The memory 148 can include one or more readily available types of memory, such as read only memory (ROM) (e.g., electrically erasable programmable read-only memory (EEPROM), flash memory, floppy disk, hard disk, or random access memory (RAM) (e.g., non-volatile random access memory (NVRAM))).

The processor 146 can be configured to execute various programs stored in the memory 148, such as epitaxial deposition processes. During execution of these programs, the controller 108 can communicate to I/O devices through the I/O circuits 150. For example, during execution of these programs and communication through the I/O circuits 150, the controller 108 can control outputs, such as the electric power provided to the upper and lower lamps 138, 140 for heating the components in the process volume 118. The memory 148 can further include various operational settings used to control the processing system 100. For example, the settings can include temperature thresholds and/or power levels for the upper lamps 138 and/or lower lamps 140 for different processes.

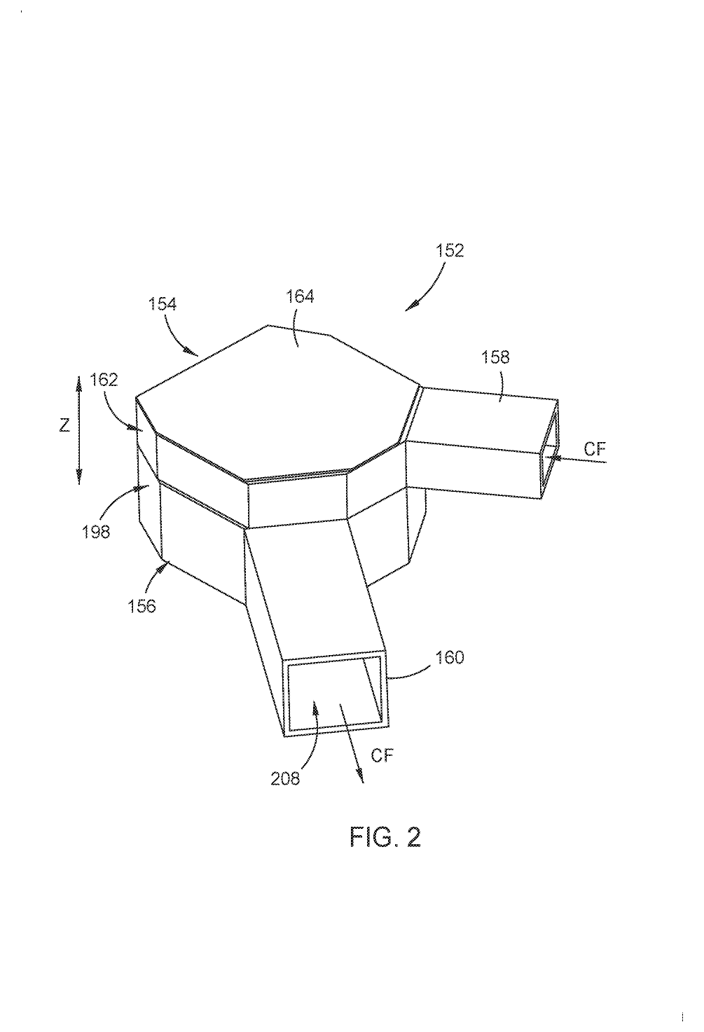

The process chamber 102 also includes an upper chamber assembly 152. The upper lamps 138 and the outer and inner reflectors 142, 144 can be components of the upper chamber assembly 152. The upper chamber assembly 152 has an upper assembly 154 and a lower assembly 156. The upper assembly 154 is arranged on top of the lower assembly 156, e.g., along the third direction Z. The upper assembly 154 has an inlet duct 158 that can deliver a cooling fluid CF (e.g., air) into the upper chamber assembly 152, e.g., during epitaxial deposition. Generally, the cooling fluid CF provided to the upper chamber assembly 152 can flow initially through an outer passage of the upper assembly 154 and to the upper lamps 138 to provide cooling thereto. The cooling fluid CF can also travel to the lower assembly 156 and along the upper window 114 to provide cooling thereto. The lower assembly 156 includes an outlet duct 160 (FIG. 2) through which the cooling fluid CF can be exhausted from the upper chamber assembly 152. As will be explained in greater detail below, the upper chamber assembly 152 includes features for enhancing the cooling of the upper lamps 138 as well as the upper window 114.

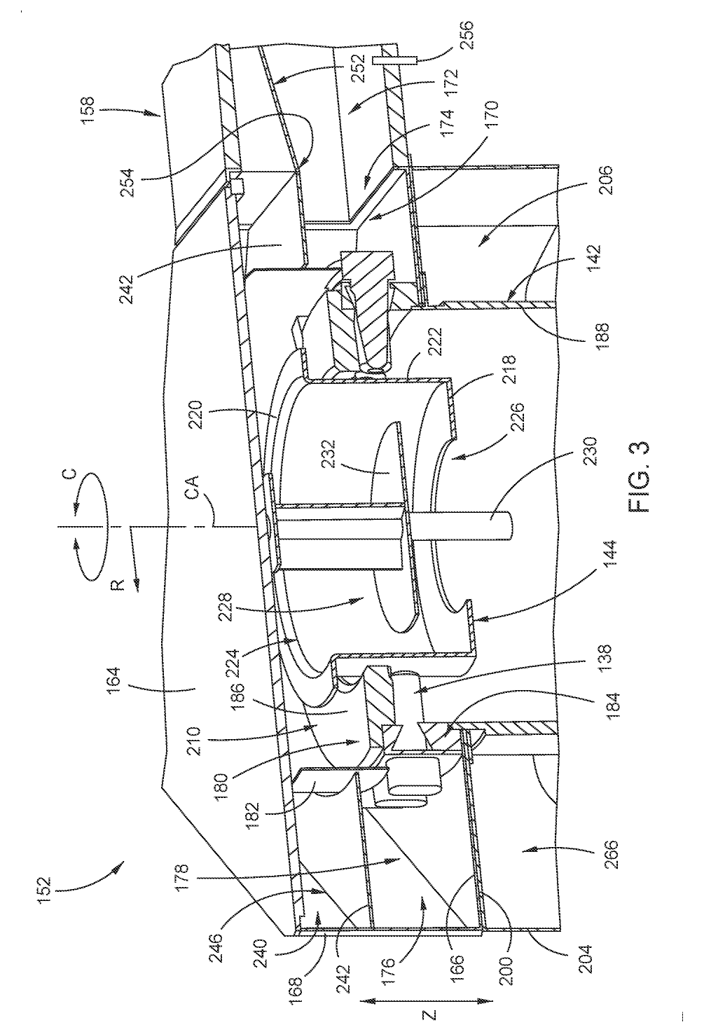

With reference now to FIGS. 2 and 3, the upper chamber assembly 152 will be described in detail. FIG. 2 is a perspective view of the upper chamber assembly 152 and FIG. 3 is a perspective cross-sectional view of a portion of the upper chamber assembly 152. For reference, the upper chamber assembly 152 can define a central axis CA extending along the third direction Z (or axial direction), a radial direction R, and a circumferential direction C.

As illustrated, the upper chamber assembly 152 has the upper assembly 154 and the lower assembly 156, with the upper assembly 154 being arranged on top of the lower assembly 156, e.g., along the third direction Z. The upper assembly 154 includes an upper housing 162 formed by a lid 164, a base wall 166, and an upper sidewall 168 extending between and connecting the lid 164 and the base wall 166. The upper housing 162 defines an upper chamber 170 in which a number of components are arranged as shown in FIG. 3. The upper assembly 154 also includes the inlet duct 158. The inlet duct 158 defines an inlet passage 172 that is fluidly coupled with the upper chamber 170. Specifically, as depicted in FIG. 3, the inlet passage 172 is fluidly coupled with an inlet 174 of the upper chamber 170. In this regard, the cooling fluid CF (e.g., air) can flow along the inlet passage 172 of the inlet duct 158 and into the upper chamber 170 of the upper housing 162, or more specifically, into a lower section 176 of an outer passage 178 of the upper chamber 170. As will be explained in detail below, a portion of the cooling fluid CF can flow over the upper lamps 138 to provide cooling thereto.

The upper assembly 154 also includes an upper lamp module 180 and a shroud 182, which are both arranged in the upper chamber 170. The upper lamp module 180 has a lamp holder 184 arranged to hold the upper lamps 138. The lamp holder 184 can be an annular component holding the circumferentially arranged upper lamps 138 or can include a plurality of circumferentially-arranged lamp holder segments each arranged to hold at least one of the upper lamps 138. The upper lamp module 180 also has a lamp support 186 that extends circumferentially and is arranged above the upper lamps 138. The lamp support 186 can be a ring-like structure that directs heat downward, e.g., toward the upper window 114 (FIG. 1). The upper lamp module 180 is connected to an outer reflector sidewall 188 of the outer reflector 142.

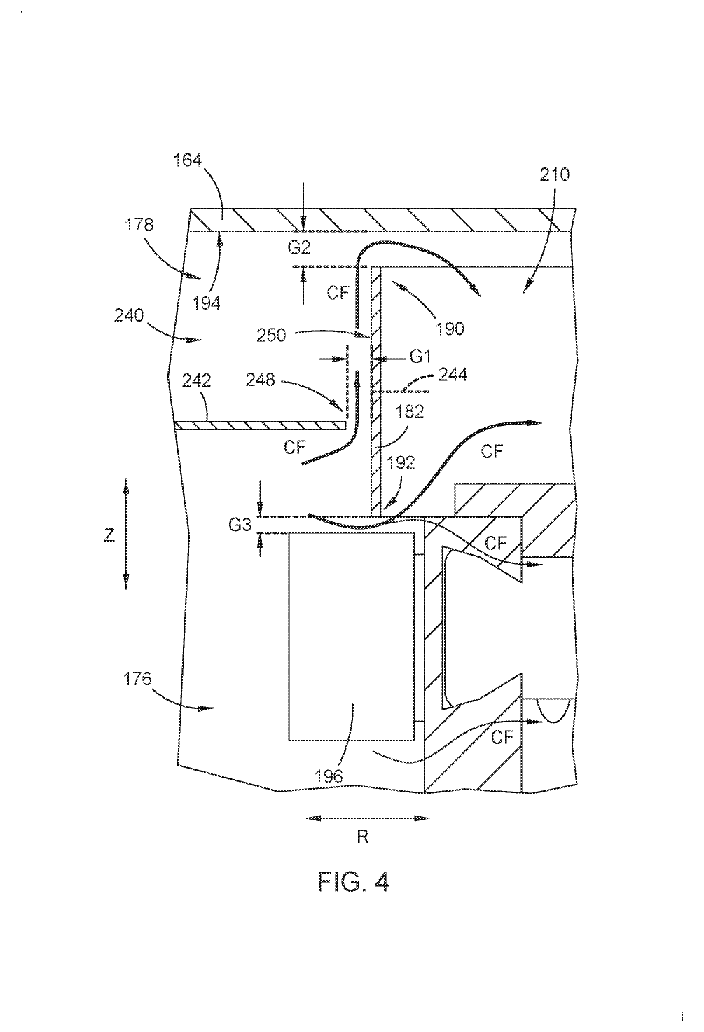

The shroud 182 is connected to the upper lamp module 180. The shroud 182 is generally vertically-oriented and thus can be arranged perpendicular to the lid 164. The shroud 182 extends within the upper chamber 170 along the circumferential direction C with respect to the central axis CA. The shroud 182 can extend annularly or can include circumferentially-spaced segments. As shown in the close-up cross-sectional view of FIG. 4, the shroud 182 has an upper end 190 and a lower end 192. The upper end 190 of the shroud 182 is spaced from a lower surface 194 of the lid 164 by a gap G2. Accordingly, the gap G2 is defined between the upper end 190 of the shroud 182 and the lower surface 194 of the lid 164. The lower end 192 of the shroud 182 is spaced from the upper lamp module 180 (or in this example, respective sockets 196 of the upper lamps 138) by a gap G3. Accordingly, the gap G3 is defined between the lower end 192 of the shroud 182 and the upper lamp module 180.

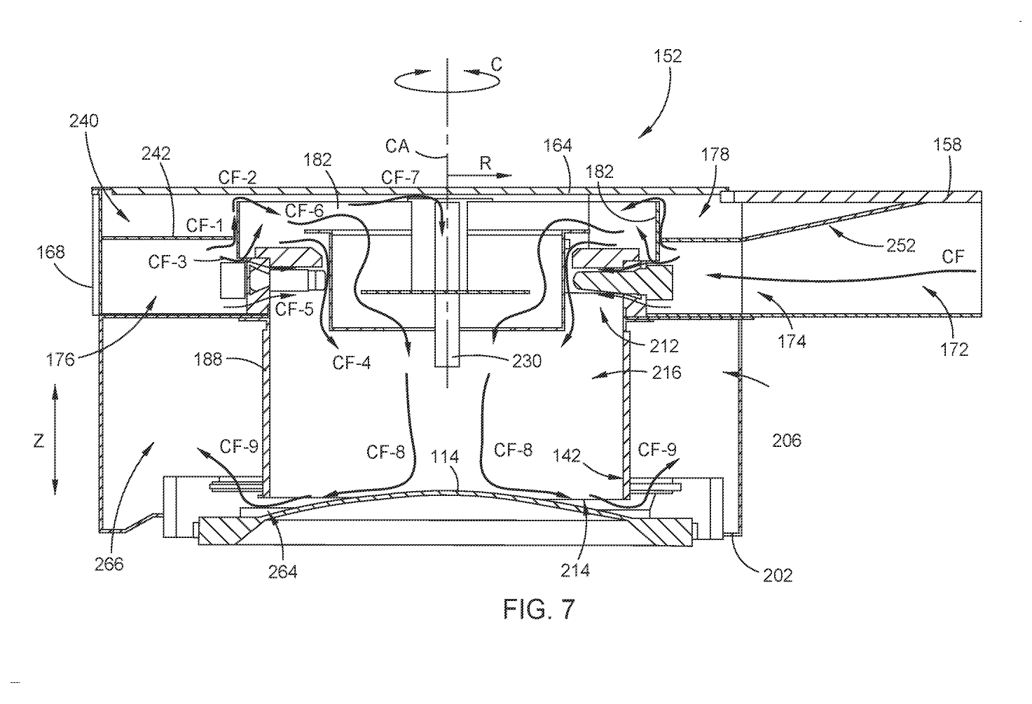

Referring to FIGS. 2 and 3, the lower assembly 156 includes a lower housing 198 formed by a top wall 200, a base wall 202 (FIG. 7), and a lower sidewall 204 that extends between and connects the top wall 200 and the base wall 202. The base wall 166 of the upper housing 162 can be seated on or in planar-to-planar engagement with the top wall 200 of the lower housing 198. The lower housing 198 defines a lower chamber 206. The lower assembly 156 also includes the outlet duct 160. The outlet duct 160 defines an outlet passage 208 that is fluidly coupled with the lower chamber 206. Specifically, the outlet passage 208 is fluidly coupled with the lower chamber 206 at an outlet of the lower chamber 206. In this regard, after cooling the upper lamps 138 and flowing to the lower chamber 206 by way of an interior volume 210 as will be described in detail herein, the cooling fluid CF can flow from the lower chamber 206 of the lower housing 198 into the outlet passage 208 of the outlet duct 160. Accordingly, the cooling fluid CF can be exhausted from the upper chamber assembly 152 by way of the outlet duct 160.

The outer reflector 142 is arranged in part in the upper chamber 170 and in part in the lower chamber 206. Particularly, the base wall 166 of the upper housing 162 and the top wall 200 of the lower housing 198 define complementary openings sized to receive the outer reflector 142. In this way, the outer reflector 142 can extend therethrough so as to be arranged in part in the upper chamber 170 and in part in the lower chamber 206. The outer reflector 142 has the outer reflector sidewall 188. The outer reflector 142 defines an upper opening 212 (FIG. 7) at an upper end of the outer reflector 142 and a lower opening 214 at a lower end of the outer reflector 142 (FIG. 7). A portion of the upper window 114 can extend through the lower opening 214 and into an outer reflector volume 216 defined by the outer reflector 142 (see FIGS. 1 and 7). The outer reflector 142, the upper lamp module 180, and the shroud 182 define the interior volume 210. In this regard, the outer reflector volume 216 forms part of the interior volume 210.

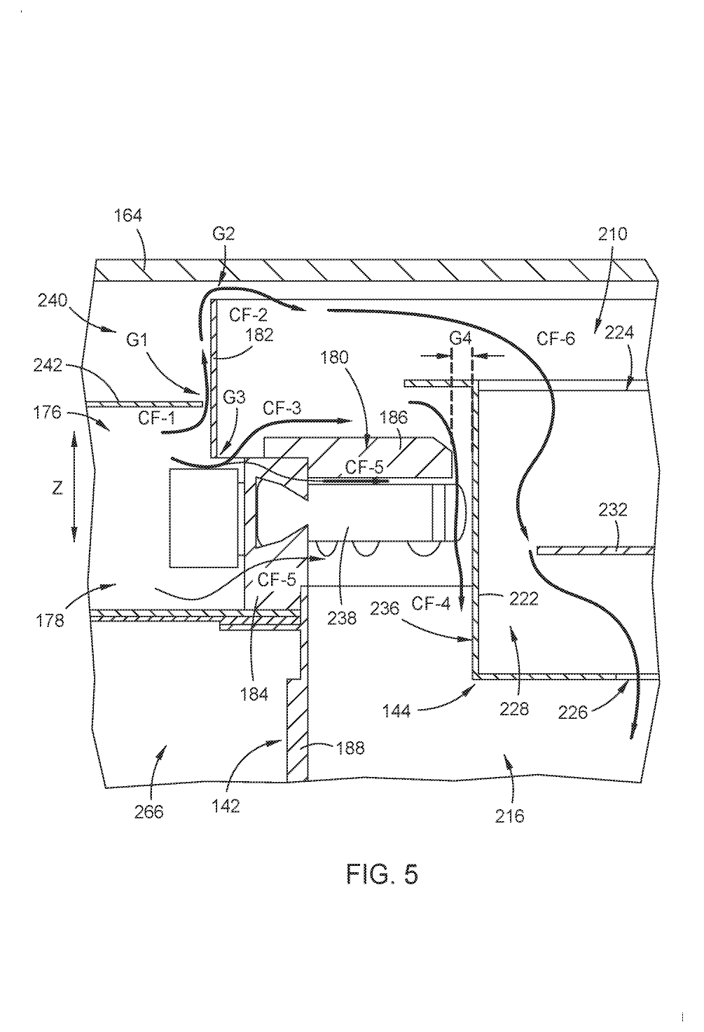

The inner reflector 144 is arranged within the interior volume 210. The inner reflector 144 has an inner reflector base wall 218, an upper flange 220, and an inner reflector sidewall 222 that extends between and connects the inner reflector base wall 218 and the upper flange 220. The inner reflector 144 extends between an upper end and a lower end, e.g., along the third direction Z. The inner reflector 144 defines an upper opening 224 at its upper end and a lower opening 226 at its lower end. The inner reflector base wall 218 and the inner reflector sidewall 222 define an inner reflector volume 228. A shaft 230 having a platform 232 coupled thereto can be arranged in the inner reflector volume 228. The shaft 230 can be a hollow shaft, for example. Further, as shown in FIG. 5, a gap G4 can be defined between an outer surface 236 of the inner reflector sidewall 222 and the upper lamp module 180.

As illustrated in FIG. 3, the lid 164, the base wall 166, and the upper sidewall 168 of the upper housing 162 as well as the upper lamp module 180 and the shroud 182 define the outer passage 178 of the upper chamber 170. The outer passage 178 extends around the upper lamp module 180 and the shroud 182 (e.g., by three hundred sixty degrees (360°)). The sockets 196 (FIG. 4) of the upper lamps 138 can be arranged within the outer passage 178 while the bulbs 238 (FIG. 5) of the upper lamps 138 can extend into the interior volume 210. As noted previously, the lower section 176 of the outer passage 178 is fluidly coupled with the inlet 174. In this way, the cooling fluid CF being delivered to the upper chamber 170 can be directed through the inlet 174 and the cooling fluid CF can initially fill the lower section 176 of the outer passage 178.

The outer passage 178 can be separated into an upper section 240 and the lower section 176 by a baffle 242. The baffle 242 is generally horizontally-oriented and can be arranged in a plane perpendicular to the third direction Z. Accordingly, the baffle 242 can be arranged parallel to the lid 164. In some embodiments, the baffle 242 is arranged along the third direction Z so that the lower section 176 has a greater dimension along the third direction Z than does the upper section 240, e.g., as shown in FIG. 3. In at least some further embodiments, the baffle 242 is arranged along the third direction Z so that the baffle 242 is arranged below a midpoint 244 (represented by the dashed line in FIG. 4) of a span of the shroud 182 (i.e., the length of the shroud 182 extending between the upper end 190 (FIG. 4) and the lower end 192 (FIG. 4) along the third direction Z) and above a halfway point between the lower end 192 and the midpoint 244 of the span. In other embodiments, the baffle 242 is arranged along the third direction Z so that the baffle 242 is arranged at least within ten percent (10%) of the midpoint 244 of the span of the shroud 182.

The baffle 242 extends between an outer end 246 and an inner end 248 (FIG. 4), e.g., along the radial direction R. In at least some example embodiments, the outer end 246 is coupled with or attached to the upper sidewall 168. In contrast, the inner end 248 is a free end and is spaced from an outer surface 250 of the shroud 182 by a gap G1, e.g., as shown in FIG. 4. Accordingly, a gap G1 is defined between the inner end 248 of the baffle 242 and the outer surface 250 of the shroud 182. The gap G1 provides fluid communication between the lower section 176 and the upper section 240 of the outer passage 178. The gap G1 has a radial length extending along the radial direction R and a circumferential dimension extending along the circumferential direction C. In at least some embodiments, the gap G1 can extend annularly. The baffle 242 can extend annularly or can be arranged in circumferentially-arranged segments. In some embodiments, the baffle 242 can be cantilevered from the upper housing 162, e.g., as shown in FIG. 3. In other embodiments, the baffle 242 can be supported by one or more struts or structural members, e.g., extending between and connecting the lid 164 and the baffle 242.

In at least some example embodiments, the inlet passage 172 of the inlet duct 158 is in fluid communication with the lower section 176 of the outer passage 178. As depicted in FIG. 3 (see also FIG. 7), the inlet duct 158 has a sloped ceiling 252 that gradually decreases a cross-sectional area of the inlet passage 172 as the inlet passage 172 approaches the inlet 174 of the upper chamber 170. A lower edge 254 of the sloped ceiling 252 is substantially aligned with the baffle 242, e.g., along the third direction Z. Stated another way, the lower edge 254 of the sloped ceiling 252 and the baffle are arranged at substantially a same height along the third direction Z. By gradually decreasing the cross-sectional area of the inlet passage 172 as the inlet passage 172 approaches the inlet 174, the flow of the cooling fluid CF can decrease in pressure and increase in velocity at the inlet 174, and consequently, when the cooling fluid CF enters the lower section 176 at the inlet 174, the cooling fluid CF can travel circumferentially through the lower section 176 with increased velocity. Moreover, gradually decreasing the cross-sectional area of the inlet passage 172 as the inlet passage 172 approaches the inlet 174 can usher the cooling fluid CF into the lower section 176, and not the upper section 240.

In at least some example embodiments, the baffle 242 is fixed or non-movable so that a size of the gap G1 is fixed, wherein the size refers to the radial length or dimension of the gap G1.

In at least some example embodiments, the baffle 242 is movable so that a size of the gap G1 is adjustable, wherein the size refers to the radial length or dimension of the gap G1. Adjusting the size of the gap G1 can adjust the flow of the cooling fluid CF over the upper lamps 138, e.g., by controlling the flow of the cooling fluid CF flowing to the upper section 240 through the gap G1. By decreasing or narrowing the gap G1, the flow of cooling fluid CF flowing from the lower section 176 to the upper section 240 is “choked” or decreased, which causes an increase in flow of the cooling fluid CF under the lower end 192 of the shroud 182 and over the upper lamps 138. This can increase the cooling flow over the upper lamps 138. By increasing or widening the gap G1, the flow of cooling fluid CF flowing from the lower section 176 to the upper section 240 increases or becomes less choked, which causes a decrease in flow of the cooling fluid CF under the lower end 192 of the shroud 182 and over the upper lamps 138. While this can decrease the cooling flow over the upper lamps 138, other areas may be cooled more efficiently.

In some example embodiments, for example, the baffle 242 can be automatically movable (e.g., along the radial direction R) so as to control the size of the gap G1 based at least in part on one or more operating conditions associated with the process chamber 102. For instance, with the upper lamps 138 powered up and an epitaxial process being performed, one or more operating conditions associated with the process chamber 102 (FIG. 1) can be sensed and/or predicted, e.g., by a sensor 256 (represented schematically in FIG. 3). For example, a flow rate of the cooling fluid CF flowing through the upper chamber assembly 152 can be sensed and/or predicted (at the inlet passage 172, at the upper lamps 138, at the upper window 114, and/or at other one or more other locations), the power level of the upper lamps 138 can be monitored, a working time of the upper lamps 138 can be clocked, and/or other operating conditions can be observed. The baffle 242 can be controlled, e.g., by an actuator, to move radially inward or outward based at least in part on the one or more operating conditions.

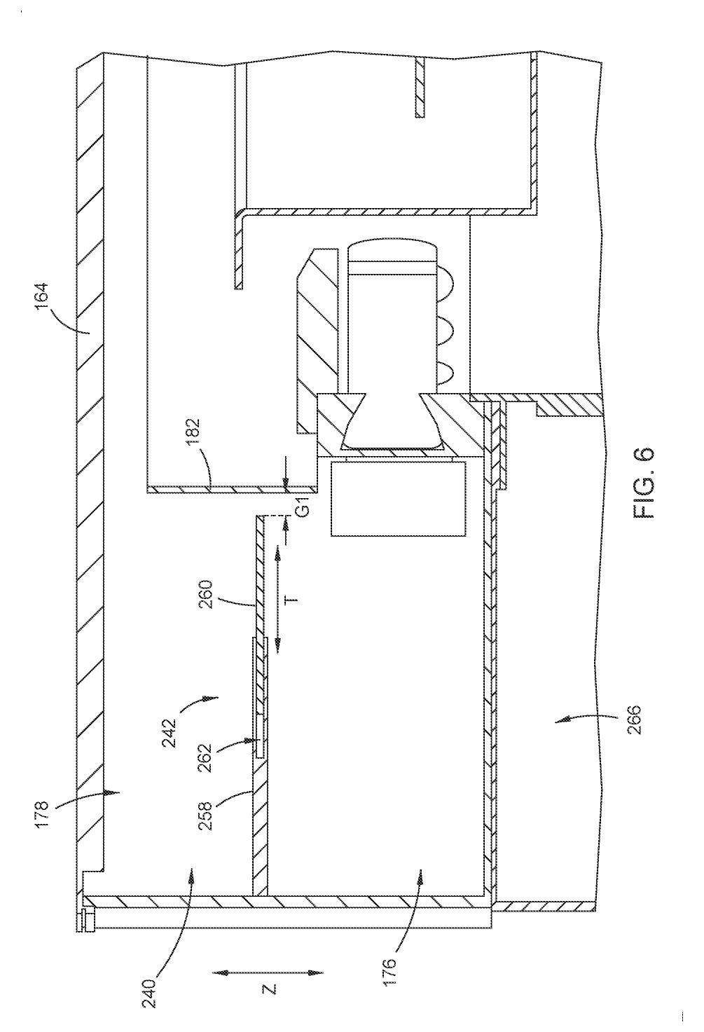

In at least some example embodiments, as shown in FIG. 6, the baffle 242 can include a rail 258 and a slider 260 that is slidable relative to the rail 258 so as to control a size (e.g., a radial dimension) of the gap G1. The rail 258 has an outer end and an inner end and generally extends radially and circumferentially in a plane orthogonal to the third direction Z. The outer end of the rail 258 is connected to the upper sidewall 168. The rail 258 defines a pocket 262 arranged to slidably receive the slider 260. The slider 260 can be slid radially inward or radially outward with respect to the central axis CA. Thus, the slider 260 can be moved along a travel direction T. The slider 260 can be extended toward the shroud 182, e.g., to narrow the gap G1, or retracted away from the shroud 182, e.g., to widen the gap G1. In this way, the gap G1 can be varied, e.g., according to one or more operating conditions associated with the process chamber 102 (FIG. 1). In other embodiments, the slider 260 can be slid relative to an external track of the rail 258.

With reference now generally to FIGS. 5 and 7, an example manner in which cooling fluid CF can pass through the upper chamber assembly 152 will now be provided.

As shown in FIG. 7, the cooling fluid CF can be delivered to the upper chamber assembly 152 by the inlet duct 158. The cooling fluid CF can be actively moved or supplied to the upper chamber assembly 152, e.g., by a fan, a blower, or the like. In at least some example embodiments, the cooling fluid CF can be delivered to the upper chamber assembly 152 at a flow rate of between 500 Cubic Feet per Minute (CFM) and 1,500 CFM, including the endpoints. As the cooling fluid CF approaches the inlet 174, the sloped ceiling 252 of the inlet duct 158 gradually decreases the cross-sectional area of the inlet passage 172, and consequently, the pressure of the cooling fluid CF is increased as the cooling fluid CF approaches the inlet 174. The sloped ceiling 252 also directs the cooling fluid CF into the lower section 176 of the outer passage 178, and not the upper section 240. Accordingly, in this example embodiment, the cooling fluid CF does not flow directly from the inlet duct 158 into the upper section 240. When the cooling fluid CF enters the lower section 176 at the inlet 174, the cooling fluid CF can travel generally circumferentially through the lower section 176, with a portion of the cooling fluid CF traveling clockwise and a portion of the cooling fluid CF traveling counterclockwise to fill the lower section 176 of the outer passage 178.

As shown in FIG. 5, a portion of cooling fluid CF-1 flowing through the lower section 176 of the outer passage 178 can exit the lower section 176 through the gap G1 defined between the baffle 242 and the shroud 182. The portion of cooling fluid CF-1 flowing through the gap G1 exits the lower section 176 and enters the upper section 240 of the outer passage 178. The portion of cooling fluid CF-1 can flow generally upward along the third direction Z through the upper section 240 as a narrow jet due to the relatively narrow gap G1. Some of the portion of cooling fluid CF-1 can depart away from the narrow jet to fill the upper section 240. A portion of cooling fluid CF-2 contained in the upper section 240 can flow through the gap G2 defined between the upper end 190 (FIG. 4) of the shroud 182 and the lid 164. Accordingly, the portion of cooling fluid CF-2 can enter the interior volume 210, which is defined by the shroud 182, the upper lamp module 180, and the outer reflector 142.

Further, as illustrated in FIG. 5, a portion of cooling fluid CF-3 flowing through the lower section 176 of the outer passage 178 can exit the lower section 176 through the gap G3 defined between the lower end 192 (FIG. 4) of the shroud 182 and the upper lamp module 180. The portion of cooling fluid CF-3 can thus exit the lower section 176 and enter the interior volume 210. Accordingly, the portion of cooling fluid CF-3 exiting the lower section 176 can flow generally inward along the radial direction R toward the upper lamps 138 to provide cooling thereto. For instance, as shown in FIG. 5, the portion of cooling fluid CF-3 can flow over the top of the lamp support 186, which can provide cooling to the upper lamps 138.

Further, as depicted in FIG. 5, a portion of cooling fluid CF-4 can flow through the gap G4 defined between the upper lamp module 180 and the inner reflector 144. The portion of cooling fluid CF-4 can flow through the gap G4 generally downward along the third direction Z past the respective inner ends of the upper lamps 138 and into the outer reflector volume 216 defined by the outer reflector 142. The portion of cooling fluid CF-4 can be formed at least in part by the portions of cooling fluid CF-2 and CF-3. The portion of cooling fluid CF-4 flows generally as a narrow jet due to the relatively narrow gap G4.

As further depicted in FIG. 5, a portion of cooling fluid CF-5 flowing through the lower section 176 of the outer passage 178 can exit the lower section 176 through the gap G3 defined between the lower end 192 (FIG. 4) of the shroud 182 and the upper lamp module 180. The portion of cooling fluid CF-5 can thus exit the lower section 176 and enter the interior volume 210. Accordingly, the portion of cooling fluid CF-5 exiting the lower section 176 can flow generally inward along the radial direction R toward the upper lamps 138 to provide cooling thereto. Particularly, as shown in FIG. 5, the portion of cooling fluid CF-5 can flow through passages defined between the lamp holder 184 and the upper lamps 138 and can flow over the upper lamps 138 between the upper lamps 138 and the lamp support 186. Further, some of the portion of cooling fluid CF-5 can flow from the lower section 176 directly into the passages and can flow generally radially inward below the upper lamps 138 to provide cooling to the undersides of the upper lamps 138.

As further illustrated in FIG. 5, a portion of cooling fluid CF-6 can flow through the inner reflector 144, e.g., in a generally downward direction along the third direction Z. In particular, the portion of cooling fluid CF-6 can flow through the upper opening 224 of the inner reflector 144 and into the inner reflector volume 228, around the platform 232, and through the lower opening 226 of the inner reflector 144. The portion of cooling fluid CF-6 can exit the inner reflector volume 228 and enter the outer reflector volume 216. The portion of cooling fluid CF-6 can be formed at least in part by the portions of cooling fluid CF-2 and CF-3. Moreover, as shown in FIG. 7, a portion of cooling fluid CF-7 can flow through the shaft 230, e.g., in a generally downward direction along the third direction Z. When the portion of cooling fluid CF-7 exits the shaft 230, the portion of cooling fluid CF-7 can enter the outer reflector volume 216. The portion of cooling fluid CF-7 can be formed at least in part by the portions of cooling fluid CF-2 and CF-3. In embodiments in which the shaft 230 is not hollow, the portion of cooling fluid CF-7 is not present.

As depicted in FIG. 7, a portion of cooling fluid CF-8 flowing through the outer reflector volume 216 can flow along the upper window 114 to provide cooling thereto. The portion of cooling fluid CF-8 can flow outward along the radial direction R along the upper window 114. The portion of cooling fluid CF-8 can be formed by the portions of cooling fluid CF-4, CF-5, CF-6, and CF-7. A combination of the cooling fluid flowing through the interior volume 210, represented by a portion of cooling fluid CF-9, can exit the interior volume 210 through an opening 264 or gap between the outer reflector 142 and the upper window 114. The portion of cooling fluid CF-9 exiting the interior volume 210 through the opening 264 can flow into a lower outer passage 266 of the lower chamber 206. The cooling fluid CF can flow generally circumferentially through the lower outer passage 266 to the outlet duct 160 (FIG. 2), where the cooling fluid CF can be exhausted from the upper chamber assembly 152 through the outlet duct 160.

The arrangement of the upper chamber assembly 152 arranged as disclosed can provide one or more advantages, benefits, and/or technical effects. For instance, the upper chamber assembly 152 having the baffle 242 arranged as disclosed herein can increase the radially flow to the upper lamps 138, which can enhance the cooling thereof. The baffle 242 can facilitate cooling of the upper lamps 138 by increasing the flow of cooling fluid CF under the shroud 182 to the upper lamps 138. Effectively, the cooling fluid CF is focused into the lower section 176 of the outer passage 178 and “choked” at the first gap G1 so as to enhance the flow of the cooling fluid CF to the upper lamps 138. Enhancing the cooling of the upper lamps 138 can provide improved performance and service life of the upper lamps 138. Further, even with enhancing the flow to the upper lamps 138, a portion of the cooling fluid CF is still allowed to flow from the lower section 176 to the upper section 240 through the gap G1 and through the second gap G2 so as to allow cooling of components within the interior volume 210. These flows can combine to cool the upper window 114.

Not only can the baffle 242 facilitate cooling of the upper lamps 138, the baffle 242 also can enable increased flow uniformity of the cooling fluid CF over each of the upper lamps 138, which can ensure that each one of the upper lamps 138 is cooled to specification and so that the upper lamps 138 have more uniform useful service lives. In addition, the arrangement of the baffle 242 can produce flows of the cooling fluid CF (i.e., the portions of cooling fluid CF-2, CF-3, which are both dependent on the portion of cooling fluid CF-1) that effectively combine to provide increased flow uniformity of the cooling fluid CF through the gap G4, which can further enhance the cooling of the upper lamps 138 and provide a more uniform flow of the cooling fluid CF over the upper window 114. This can effectively enhance the precision and repeatability of epitaxial deposition taking place in the process volume 118 defined in part by the upper window 114.

In addition, as noted previously, the gap G1 can be adjusted in some embodiments by moving the baffle 242, e.g., based at least in part on one or more operating conditions associated with the process chamber 102. For instance, the baffle 242 can be arranged as shown in FIG. 6, with the slider 260 being movable relative to the rail 258. An actuator or the like can be controlled (e.g., by the controller 108) to move the slider 260, which can ultimately adjust the “choke” provided at the gap G1, and consequently, the radially flow of the cooling fluid CF to the upper lamps 138. In some embodiments, the slider 260 of the baffle 242 can be manually controlled, e.g., by way of a manually-adjustable arm coupled with the slider 260. In some embodiments, instead of the baffle 242 having the slider 260 and the rail 258, the baffle 242 can have other configurations that enable movement thereof to adjust the radial dimension of the gap G1.

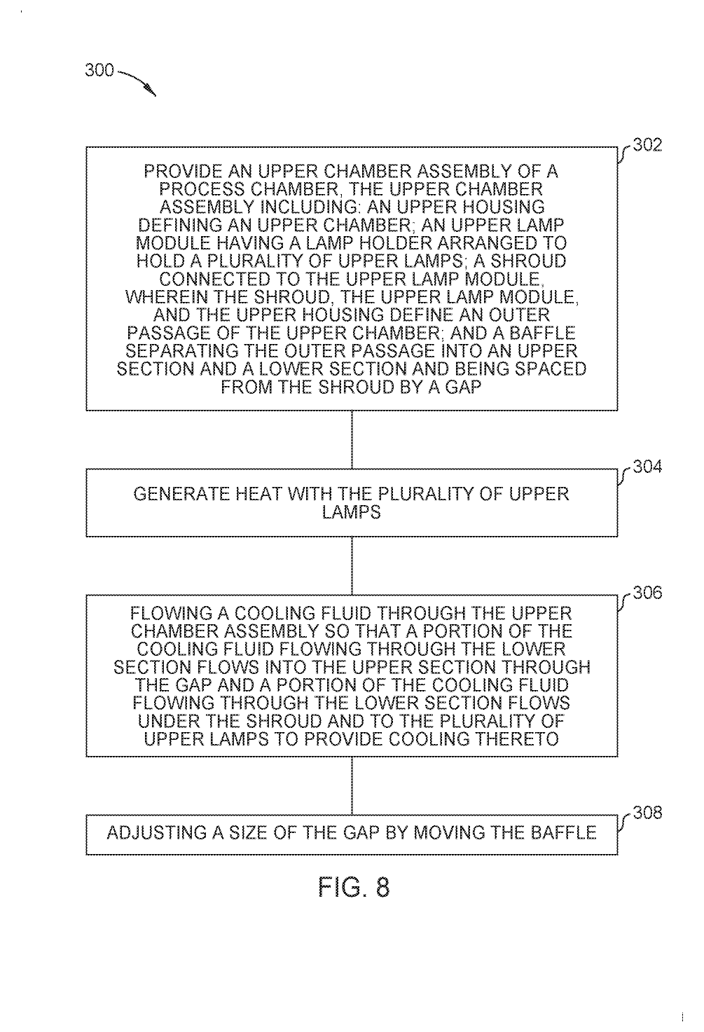

FIG. 8 is a flow diagram for a method 300 of operating a processing system, such as a semiconductor processing system. For instance, the processing system 100 of FIG. 1 can be operated according to the method 300.

At 302, the method 300 can include providing an upper chamber assembly of a process chamber. The upper chamber assembly can include: an upper housing defining an upper chamber; an upper lamp module having a lamp holder arranged to hold a plurality of upper lamps; a shroud connected to the upper lamp module, wherein the shroud, the upper lamp module, and the upper housing define an outer passage of the upper chamber; and a baffle separating the outer passage into an upper section and a lower section and being spaced from the shroud by a gap. For instance, the upper chamber assembly can be arranged as disclosed herein.

At 304, the method 300 can include generating heat with the plurality of upper lamps, e.g., to process a substrate arranged within a process volume of the process chamber. For instance, to process the substrate in a process, such as an epitaxial deposition process, the upper lamps are powered up to provide heat to the substrate, and more generally, to the process volume in which the substrate is positioned. The upper lamps can be powered up for other cycles of the processing system as well, such as a cleaning cycle. In addition, other lamps, such as lower lamps of the process chamber, can be powered up to provide heat to the substrate and/or process volume.

At 306, the method 300 can include flowing a cooling fluid through the upper chamber assembly so that a portion of the cooling fluid flowing through the lower section flows into the upper section through the gap and a portion of the cooling fluid flowing through the lower section flows under the shroud and to the plurality of upper lamps to provide cooling thereto. For instance, a fan, air mover, or the like can be controlled to move a cooling fluid into the upper chamber assembly. The cooling fluid can enter the upper chamber assembly by way of an inlet passage defined by an inlet duct. The inlet duct can include a sloped ceiling that focuses the cooling fluid into the lower section, and not the upper section. The cooling fluid enters the lower section and flows generally circumferentially through the outer passage.

A portion of the cooling fluid can exit the lower section through the gap defined between an inner end of the baffle and the shroud. The gap is relatively narrow, and thus, the gap provides a “choke” or bottleneck in the flow exiting to the upper section. The choked flow at the gap facilitates cooling fluid flowing through the lower section to flow more directly to the upper lamps (e.g., through a gap defined between a lower end of the shroud and the upper lamp module) to provide cooling thereto. In this way, the flow over the upper lamps can be enhanced, which can extend the service lives of the upper lamps. The arrangement of the baffle relative to the shroud also advantageously creates a more uniform flow over the upper lamps.

The cooling fluid that enters the upper section can flow through a gap defined between an upper end of the shroud and a lid of the upper housing. This flow of cooling fluid can enter an interior volume defined by the shroud, the upper lamp module, and an outer reflector. The cooling fluid can flow through this interior volume in a generally downward direction. The portion of cooling fluid that traveled through the gap defined between the lower end of the shroud and the upper lamp module can flow into the interior volume and over, around, and between the upper lamps and can combine with the cooling fluid that traveled through the gap between the upper end of the shroud and the lid. The combined flow can flow along an upper dome defining the process volume. The combined flow flows along the upper dome outside of the process volume. That is, the combined flow does not enter the process volume. The combined flow can thus cool the upper dome. The arrangement of the baffle relative to the shroud can facilitate flow uniformity over the upper dome. The combined flow of cooling fluid can exit the interior volume and can flow into a lower outer passage of a lower chamber defined by a lower housing. The cooling fluid, which has been heated by the upper lamps, upper dome, and other components of the upper chamber assembly, can be exhausted through an outlet duct of the lower assembly. Accordingly, a cooling fluid (e.g., air) can be actively moved through the upper chamber assembly as described as a substrate is being processed in the process volume, or during another cycle (e.g., a cleaning cycle) in which the upper lamps are controlled to generate heat.

At 308, the method 300 can include adjusting a size of the gap by moving the baffle, e.g., based at least in part on one or more operating conditions associated with the process chamber. For instance, the baffle can be moved manually or automatically to adjust a radial dimension of the gap. As one example, based on a flow rate, a temperature reading, a power level of the upper lamps, an actual or predicted degradation of the upper lamps, a combination of the foregoing, or one or more other operation parameters, the baffle can be moved to adjust the gap, or radial dimension thereof. As one example, the baffle can include a slider that moves relative to a rail. Moving the slider can control the radial dimension of the gap, and consequently, the “choke” provided at the gap between the shroud and the baffle. In this way, the flow to the upper lamps can be increased or decreased according to the operating conditions of the process chamber.

While the foregoing is directed to embodiments of the present disclosure, other and further embodiments of the disclosure may be devised without departing from the basic scope thereof, and the scope thereof is determined by the claims that follow.

What is claimed is:

1. A process chamber, comprising:
an upper housing defining an upper chamber;
an upper lamp module having a lamp holder arranged to hold a plurality of upper lamps;
a shroud connected to the upper lamp module, wherein the shroud, the upper lamp module, and the upper housing define an outer passage of the upper chamber; and
a baffle separating the outer passage into an upper section and a lower section, the baffle being arranged to facilitate a flow of a cooling fluid flowing through the lower section to the plurality of upper lamps to provide cooling thereto.

2. The process chamber of claim 1, wherein the upper housing has a base wall, a lid, and a sidewall extending between and connecting the base wall and the lid, and wherein the baffle extends from the sidewall toward the shroud.

3. The process chamber of claim 2, wherein the baffle is arranged parallel to the lid and the shroud is arranged perpendicular to the lid.

4. The process chamber of claim 1, wherein a gap is defined between an inner end of the baffle and an outer surface of the shroud, the gap provides fluid communication between the lower section and the upper section of the outer passage.

5. The process chamber of claim 4, wherein the baffle is movable so that a size of the gap is adjustable.

6. The process chamber of claim 5, wherein the baffle is automatically movable so as to control the size of the gap based at least in part on one or more operating conditions associated with the process chamber.

7. The process chamber of claim 4, wherein the baffle has a rail and a slider that is slidable relative to the rail so as to control a size of the gap.

8. The process chamber of claim 1, further comprising:
an inlet duct defining an inlet passage in fluid communication with the lower section of the outer passage, and wherein the inlet duct has a sloped ceiling that gradually decreases a cross-sectional area of the inlet passage as the inlet passage approaches an inlet of the lower section.

9. The process chamber of claim 1, further comprising:
a lower housing defining a lower chamber;
an outer reflector, and wherein the outer reflector and the lower housing define a lower outer passage of the lower chamber; and
an outlet duct defining an outlet passage in fluid communication with the lower outer passage.

10. The process chamber of claim 9, wherein the outer reflector defines an interior volume and extends in part into the upper chamber and in part into the lower chamber.

11. The process chamber of claim 1, further comprising:
an outer reflector; and
an inner reflector, and
wherein the outer reflector, the upper lamp module, and the shroud define an interior volume, and wherein the inner reflector is arranged within the interior volume.

12. The process chamber of claim 11, wherein a gap is defined between the shroud and a lid of the upper housing, and wherein the gap is arranged to allow a portion of the cooling fluid to flow into the interior volume, through an inner reflector volume defined by the inner reflector, through an outer reflector volume defined by the outer reflector, and along a dome defining a process volume of the process chamber.

13. The process chamber of claim 11, wherein a gap is defined between an outer surface of the inner reflector and the upper lamp module, and wherein the gap is arranged to allow a portion of the cooling fluid to flow into an outer reflector volume defined by the outer reflector and along a dome defining a process chamber of the process chamber.

14. The process chamber of claim 1, wherein a gap is defined between a lower end of the shroud and the upper lamp module, the gap being arranged to allow the flow of the cooling fluid over the lamp holder to cool the plurality of upper lamps.

15. A process chamber, comprising:
an upper housing defining an upper chamber and having a base wall, a lid, and a sidewall extending between and connecting the base wall and the lid;
an upper lamp module positioned within the upper chamber and having a lamp holder arranged to hold a plurality of upper lamps;
a shroud connected to the upper lamp module, wherein the shroud, the upper lamp module, and the upper housing define an outer passage of the upper chamber, a gap being defined between the lid and an upper end of the shroud;
a baffle connected to the sidewall and extending toward the shroud to separate the outer passage into an upper section and a lower section, an inner end of the baffle being spaced from the shroud to define a gap; and
an inlet duct arranged to deliver a cooling fluid to the lower section, and
wherein the gap defined between the inner end of the baffle and the shroud allows a portion of the cooling fluid flowing along the lower section to flow from the lower section into the upper section and through the gap defined between the lid and the upper end of the shroud and facilitates a portion of the cooling fluid flowing through the lower section to flow under the shroud and to the upper lamps to provide cooling thereto.

16. The process chamber of claim 15, wherein the process chamber defines a vertical direction, and wherein the baffle is arranged along the vertical direction so that the lower section has a greater dimension along the vertical direction than does the upper section.

17. The process chamber of claim 15, wherein the process chamber defines a vertical direction, and wherein the baffle is arranged along the vertical direction so that the baffle is arranged below a midpoint of a span of the shroud and above a halfway point between a lower end of the shroud and the midpoint of the span.

18. The process chamber of claim 15, further comprising:
an upper dome defining a process volume;
a lower housing disposed below the upper housing and defining a lower chamber; and
an outer reflector arranged in part in the upper chamber and in part in the lower chamber, the upper dome extends at least in part into an outer reflector volume defined by the outer reflector,
wherein the outer reflector, the upper lamp module, and the shroud define an interior volume, and
wherein a portion of the cooling fluid flows through the interior volume and along the upper dome before exiting to the lower chamber.

19. A method, comprising:
providing an upper chamber assembly of a process chamber, the upper chamber assembly comprising: an upper housing defining an upper chamber; an upper lamp module having a lamp holder arranged to hold a plurality of upper lamps; a shroud connected to the upper lamp module, wherein the shroud, the upper lamp module, and the upper housing define an outer passage of the upper chamber; and a baffle separating the outer passage into an upper section and a lower section and being spaced from the shroud by a gap;
generating heat with the plurality of upper lamps; and
flowing a cooling fluid through the upper chamber assembly so that a portion of the cooling fluid flowing through the lower section flows into the upper section through the gap and a portion of the cooling fluid flowing through the lower section flows under the shroud and to the plurality of upper lamps to provide cooling thereto.

20. The method of claim 19, further comprising:
adjusting a size of the gap by moving the baffle based at least in part on one or more operating conditions associated with the process chamber.
